(19) United States
(12) Patent Application Publication
(10) Pub. No.: US 2025/0190384 A1
(43) Pub. Date: Jun. 12, 2025

(54) SYSTEMS, METHODS, AND APPARATUS FOR DIE-TO-DIE SYSTEM WITH LANE INTERLEAVING AND ERROR CORRECTION CODING WITH RETRY

(71) Applicant: Samsung Electronics Co., Ltd., Suwon-si (KR)

(72) Inventors: Soon Ju KIM, San Jose, CA (US); Si Yung PARK, San Jose, CA (US)

(21) Appl. No.: 18/963,357

(22) Filed: Nov. 27, 2024

Related U.S. Application Data
(60) Provisional application No. 63/608,819, filed on Dec. 11, 2023.

(51) Int. Cl. G06F 13/36; G06F 11/07

(52) U.S. Cl. CPC G06F 13/36; G06F 11/0745; G06F 11/0784; G06F 2213/40

(57) ABSTRACT

An apparatus may include a die including at least one circuit configured to receive a first byte mapped to a first lane of two or more lanes of a die-to-die system, receive a second byte mapped to a second lane of the two or more lanes of the die-to-die system, transmit, using one lane of the two or more lanes of the die-to-die system, a portion of the first byte, and transmit, using the one lane of the two or more lanes of the die-to-die system, a portion of the second byte. The one lane of the two or more lanes of the die-to-die system may be the first lane of the two or more lanes of the die-to-die system. The one lane of the two or more lanes of the die-to-die system may be a third lane of the two or more lanes of the die-to-die system.

### REFERENCE TO RELATED APPLICATION

This application claims priority to, and the benefit of, U.S. Provisional Patent Application Ser. No. 63/608,819 filed Dec. 11, 2023 which is incorporated by reference.

### TECHNICAL FIELD

This disclosure relates generally to die-to-die systems, and more specifically to systems, methods, and apparatus for die-to-die systems with lane interleaving and error correction coding with retry.

### BACKGROUND

A die-to-die (D2D) system may be used to transfer data between integrated circuit dies. In some embodiments, a D2D system may be implemented with a system including one or more layers that may transfer data between dies using one or more lanes, perform error detection, error correction, and/or retry operations, implement one or more communication protocols, and/or the like. In some embodiments, a D2D system may include one or more modules to implement one or more links having one or more lanes between dies.

The above information disclosed in this Background section is only for enhancement of understanding of the background of the inventive principles and therefore it may contain information that does not constitute prior art.

### SUMMARY

An apparatus may include a die including at least one circuit configured to receive a first byte mapped to a first lane of two or more lanes of a die-to-die system, receive a second byte mapped to a second lane of the two or more lanes of the die-to-die system, transmit, using one lane of the two or more lanes of the die-to-die system, a portion of the first byte, and transmit, using the one lane of the two or more lanes of the die-to-die system, a portion of the second byte. The one lane of the two or more lanes of the die-to-die system may be the first lane of the two or more lanes of the die-to-die system. The one lane of the two or more lanes of the die-to-die system may be a third lane of the two or more lanes of the die-to-die system. The portion of the first byte may be a first portion of the first byte, the portion of the second byte may be a first portion of the second byte, the one lane of the two or more lanes of the die-to-die system may be a first one lane of the two or more lanes of the die-to-die system, and the at least one circuit may be configured to generate a fourth byte including a second portion of the first byte and a second portion of the second byte, and transmit, using a second one lane of the two or more lanes of the die-to-die system, the fourth byte. The second one lane of the two or more lanes of the die-to-die system may be the second lane of the two or more lanes of the die-to-die system. The second one lane of the two or more lanes of the die-to-die system may be a third lane of the two or more lanes of the die-to-die system. The at least one circuit may be configured to generate error correction information for the portion of the first byte and the portion of the second byte, and transmit, using a lane of the die-to-die system, at least a portion of the error correction information. The at least one circuit may be configured to generate the error correction information using variable rate coding.

An apparatus may include a die including at least one circuit configured to receive data to transmit using a die-to-die system, generate error correction information for the data, encode the data and the error correction information to generate encoded information, and transmit, using the die-to-die system, at least a portion of the encoded information. The at least one circuit may be configured to configured to generate the error correction information using variable rate coding. The at least one circuit may be configured to configured to generate the error correction information using an error correction code.

An apparatus may include a die including at least one circuit configured to receive data to transmit using a die-to-die system, generate error correction information for the data, perform a first send operation including sending the data using the die-to-die system, receive, based on the first send operation, a request, and perform, based on the request, a second send operation including sending a portion of the error correction information. The portion of the error correction information may be a first portion of the error correction information, the request may be a first request, and the at least one circuit may be further configured to receive, based on the second send operation, a second request, and perform, based on the second request, a third send operation including sending a second portion of the error correction information. The portion of the error correction information may be a first portion of the error correction information, and wherein the first send operation may include sending a second portion of the error correction information. The at least one circuit may be configured to determine the first portion of the error correction information based on a coding rate. The at least one circuit may be configured to generate the error correction information using variable rate coding. The at least one circuit may be configured to generate the error correction information using a convolutional code. The at least one circuit may be configured to generate the error correction information using a turbo code. The at least one circuit may be configured to determine the portion of the error correction information based on a coding rate. The at least one circuit may include a buffer configured to store at least a portion of the error correction information.

### BRIEF DESCRIPTION OF THE DRAWINGS

The figures are not necessarily drawn to scale and elements of similar structures or functions or portions thereof may generally be represented by reference indicators ending in, and/or containing, the same digits, letters, and/or the like, for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of an architecture for a D2D system in accordance with example embodiments of the disclosure.

FIG. 2 illustrates an embodiment of a bit arrangement within byte transfers on one or more lanes in accordance with example embodiments of the disclosure.

FIG. 3 illustrates an embodiment of a byte-to-lane mapping in accordance with example embodiments of the disclosure.

FIG. 4 illustrates an embodiment of an interface architecture for a D2D system in accordance with example embodiments of the disclosure.

FIG. 5 illustrates an embodiment of a D2D system with a lane interleaving scheme in accordance with example embodiments of the disclosure.

FIG. 6 illustrates an embodiment of an interleaving scheme in accordance with example embodiments of the disclosure.

FIG. 7 illustrates an embodiment of an interface architecture for a D2D system having interleaving and error correction in accordance with example embodiments of the disclosure.

FIG. 8 illustrates an embodiment of a retry scheme for a D2D system having error correction in accordance with example embodiments of the disclosure.

FIG. 9 illustrates an example embodiment of one or more operations of a buffer for a retry operation in accordance with example embodiments of the disclosure.

FIG. 10 illustrates another embodiment of an interface architecture for a D2D system having interleaving and error correction in accordance with example embodiments of the disclosure.

FIG. 11 illustrates an example embodiment of CRC information in data information and parity information in accordance with example embodiments of the disclosure.

FIG. 12 illustrates an embodiment of a method for transmitting information using a D2D system in accordance with example embodiments of the disclosure.

FIG. 13 illustrates an embodiment of a method for receiving information using a D2D system in accordance with example embodiments of the disclosure.

### DETAILED DESCRIPTION

A die-to-die (D2D) interconnect system (which may be referred to as a D2D system) may be used to transfer data between integrated circuit (IC) dies (which may also be referred to as chips). D2D systems may enable multiple dies to be assembled in a package, for example, as a system-in-package (SIP). This may enable different relatively small dies (which may be referred to as dielets and/or chiplets) to be adapted to perform different specialized functions (e.g., processing, input and/or output (I/O), memory, and/or the like) which, depending on the implementation details, may improve the performance, cost, and/or reliability compared to integrating the multiple functions on a single larger die. In some embodiments, a D2D system may be used to transfer data between a die in one package and a die in a different package (or other component), for example, by using a retiming circuit.

Data transferred using a D2D system may have an error rate (e.g., a bit error rate (BER)) that may be caused, for example, by noise, interference, distortion, attenuation, and/or the like, in a physical (PHY) layer, electrical connections, and/or the like, for the D2D system. One type of error pattern that may be encountered with a D2D system is a burst error pattern in which multiple symbols (e.g., bits) having errors may be associated with a physical and/or logical structure such as a channel, lane, byte, block, packet, stream, and/or the like. For example, in a burst error, multiple bits that may be adjacent or relatively close in transmission (e.g., within a byte transmitted on a lane) may have errors.

Another type of error pattern that may be encountered with a D2D system is a random error pattern in which symbols (e.g., bits) having errors may be scattered randomly across unrelated physical and/or logical structures (e.g., a single bit error within a lane, byte, stream, and/or the like.) Errors from burst errors, random errors, and/or the like, may contribute to an overall BER for a D2D system.

An interleaving scheme for a D2D system in accordance with example embodiments of the disclosure may transmit a first portion (e.g., a first bit) of a transmission unit (e.g., a byte) using a first lane and a second portion (e.g., a second bit) of the transmission unit using a second lane. Depending on the implementation details, such a lane interleaving scheme may improve the operation of an error correction scheme. For example, a specific convolutional code may be relatively effective at correcting random errors but less effective at correcting burst errors. However, a bit and/or lane interleaving scheme in accordance with example embodiments of the disclosure may spread individual errors within a burst error across multiple lanes, thereby transforming a burst error pattern into an error pattern that may be characterized as a random error pattern. Thus, depending on the implementation details, the convolutional code may effectively correct some or all of the errors that may otherwise have been more difficult to correct as part of a burst error. An interleaving scheme may be implemented, for example, with a link layer and/or other logic associated with a D2D system.

An encoding scheme for a D2D system in accordance with example embodiments of the disclosure may apply an error correction scheme to data received through a link layer interface. The encoding scheme may generate encoded information that may include error correction information (e.g., parity information) that may be used to correct one or more errors. The encoded data may be transferred through a physical layer interface to a physical layer of the D2D system. The encoding scheme may be implemented, for example, with a link layer and/or other logic associated with a D2D system. Depending on the implementation details, the encoding scheme may improve the bit error rate of data transmitted by the physical layer, for example, by enabling a receiving apparatus to correct one or more errors in the encoded data.

A retry scheme for a D2D system in accordance with example embodiments of the disclosure may send less data information and/or more error correction information based on receiving a repeat request. For example, in some embodiments, in a first transmission, logic at a transmitting side of a D2D system may send data information (e.g., a data payload) with a first amount of error correction information to a receiving apparatus. For example, the first amount of error correction information may include no parity information or a first portion of parity information for the data information. The receiving apparatus may send a repeat request to the transmitting side, for example, based on the receiving apparatus being unable to correct one or more errors in the data information based on the first amount of error correction information included with the first transmission.

Based on receiving the repeat request, the logic at the transmitting side may perform a second transmission in which it may send less data information (e.g., no data payload) along with more error correction information to the receiving apparatus. For example, the second transmission may include a first portion of parity information if the first transmission included no parity information, or a second portion of parity information if the first transmission included a first portion of parity information. The receiving apparatus may combine the error correction information sent with the second transmission with the error correction information sent with the first transmission (if any) to correct one or more errors in the data information.

Depending on the ability of the receiving apparatus to adequately correct one or more errors in the data information using the error correction information included with the second transmission, the receiving apparatus may send one or more additional repeat requests, and the logic at the transmitting side may perform one or more additional transmissions including additional error correction information (e.g., one or more additional portions of parity information for the data information).

Depending on the implementation details, a retry scheme in accordance with example embodiments of the disclosure may reduce the total amount of information involved in sending data information, for example, by reducing the number of times some or all of the data information is retransmitted (e.g., sending no data information based on retry requests) while reducing or minimizing the amount of error correction information that may be sent (e.g., initially sending little or no parity information, and progressively sending more parity information based on retry requests until the receiving apparatus has enough parity information to adequately correct one or more errors in the data information). Depending on the implementation details, this may reduce latency, reduce overhead, increase throughput, increase bandwidth, and/or the like of a D2D system.

This disclosure encompasses numerous aspects relating to D2D systems. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as protocols, error detection and/or correction algorithms, interconnect standards, numbers and/or types of components, byte-based data handling, and/or the like. However, the aspects of the disclosure are not limited to these or any other implementation details. Although some embodiments may be described in the context of D2D systems, some of the aspects may be applicable to other types of interconnects. Moreover, the terms die, dielet, chip, chiplet, and/or the like, may be used interchangeably to refer to any type of integrated circuit device. Thus, the systems, methods, apparatus, and/or all related principles disclosed herein may be applied to interconnects between any types of integrated circuit devices (regardless of any type of packaging, lack of packaging, substrates, interposers, semiconductor bridges, vias, and/or the like) and may be referred to interchangeably as D2D, chip-to-chip (C2C), die-to-chip, and/or the like.

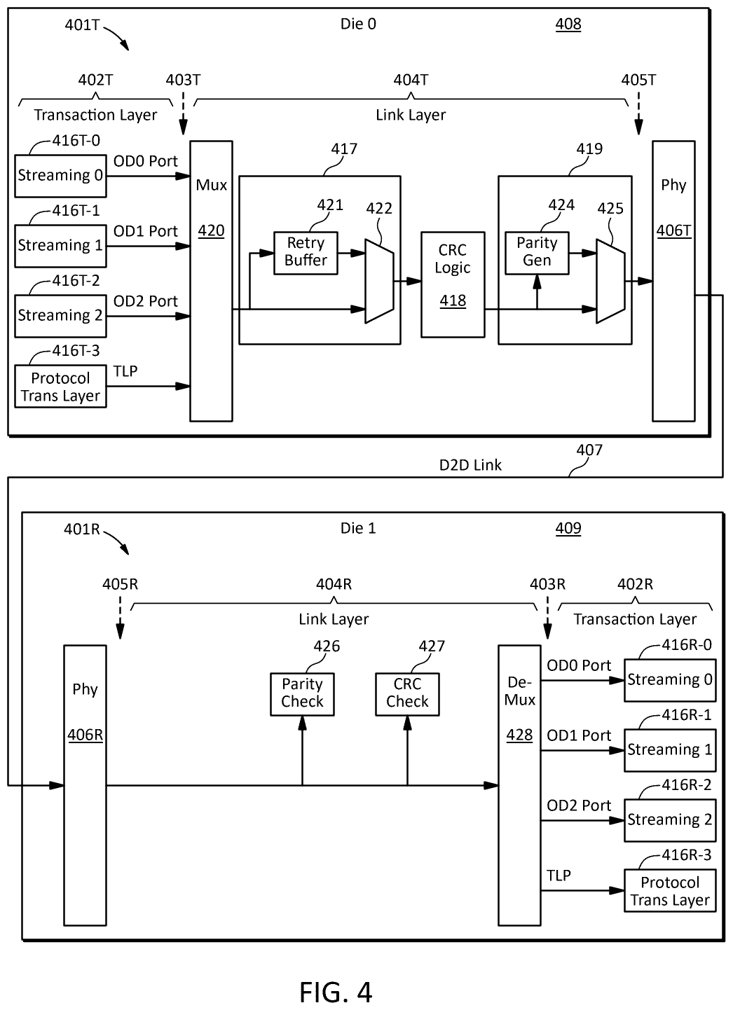

Multiple instances of elements identified with the same base numbers and different suffixes may be referred to individually and/or collectively by the base number. For example, one or more protocols 416T-1, 416T-2, 416T-3, and/or 416T-4 illustrated in FIG. 4 may be referred to individually and/or collectively as 416T. As another example, one or more protocols 416T-1, 416T-2, 416T-3, 416T-4, 416R-1, 416R-2, 416R-3, and/or 416R-4 illustrated in FIG. 4 may be referred to individually and/or collectively as 416.

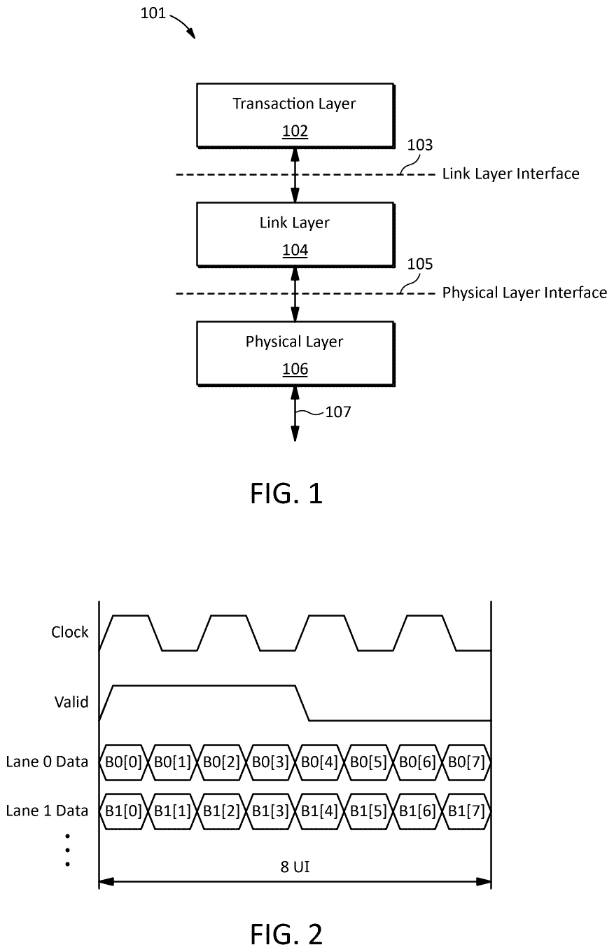

FIG. 1 illustrates an embodiment of an architecture for a D2D system in accordance with example embodiments of the disclosure. The D2D system 101 illustrated in FIG. 1 may include a transaction layer 102, a link layer 104, and/or a physical layer 106. The transaction layer 102 and link layer 104 may interact through a link layer interface 103. The link layer 104 and physical layer 106 may interact through a physical layer interface 105. The physical layer 106 may transmit and/or receive information through a link 107.

For purposes of illustration, some descriptions of the D2D system 101 illustrated in FIG. 1 may be based on an embodiment having one of each layer and/or interface, however, other embodiments may have multiples of one or more components and/or may omit one or more components. Thus, a reference to the transaction layer 102 may refer to one or more transaction layers 102, a reference to the link layer interface 103 may refer to one or more link layer interfaces 103, a reference to the link layer 104 may refer to one or more link layers 104, a reference to the physical layer interface 105 may refer to one or more physical layer interfaces 105, and/or a reference to the physical layer 106 may refer to one or more physical layers 106. Moreover, generally within this disclosure, a reference to a or the element may refer to one or multiples of the element.

Although the D2D system 101 illustrated in FIG. 1 is not limited to any specific implementation details, in some embodiments, the D2D system 101 may be implemented, a least in part, with Universal Chiplet Interconnect Express (UCle). In such an embodiment, the transaction layer 102, link layer interface 103, link layer 104, physical layer interface 105, and/or physical layer 106 may be implemented, for example, at least in part, with a protocol layer, flitaware D2D interface (FDI), adapter, raw D2D interface (RDI), and/or physical layer, respectively. Other examples of D2D protocols, standards, and/or the like, that may be implemented with, or used to implement, the D2D system 101 may include Advanced Interface Bus (AIB), Interlaken, Bunch of Wires (BOW), Open High Bandwidth Interconnect (OpenHBI), and/or the like, of any generation, version, and/or the like, or combination thereof.

In some embodiments, and depending on the context, some or all of a transaction layer 102, link layer 104, physical layer 106, link layer interface 103, physical layer interface 105, and/or link 107 may be referred to collectively as a D2D system, a chip-to-chip system, a D2D interconnect, and/or a D2D interconnect system. Additionally, or alternatively, and depending on context, some or all of the components illustrated in FIG. 1 may be referred to collectively as an interconnect, an interconnect interface, a stack, an interconnect stack, an architecture stack, interconnect logic, a partner (e.g., a remote link partner from the perspective of another D2D system that may communicate with the D2D system 101 through one or more links 107 which may be referred to as a die-to-die link, a D2D line, and/or a die link), a transmit or transmitting end of a link 107 (e.g., when the D2D system 101 is configured and/or operating to transmit information), a receive or receiving end of a link 107 (e.g., when the D2D system 101 is configured and/or operating to receive information), and/or one or more other terms that may be apparent from context. In some embodiments, and depending on the implementation details, one or more of the components, or portions thereof, illustrated in FIG. 1 may be integrated into another logical and/or physical component. For example, some or all of the transaction layer 102 may be specific to, and/or implemented by, an application (e.g., an application software layer). In such an embodiment, some or all of the transaction layer 102 may overlap with an application. In such an embodiment, and depending on the implementation details and/or context, the D2D system 101 may be characterized as excluding some or all of the transaction layer 102.

In some embodiments, a first D2D system (e.g., a first instance of the D2D system 101) may be implemented on a first die or chip, and a second D2D system (e.g., a second instance of the D2D system 101) may be implemented on a second die or chip. The first and second interfaces may be connected using one or more connections (e.g., electrical connections, optical connections, and/or the like) that may be implemented with one or more contacts, solder connections, conductors, transmission lines, and/or the like, to support one or more communication links 107 between the first and second interfaces. For example, the first and second interfaces may be connected through one or more conductors (e.g., conductive traces configured as transmission lines that may have a characteristic impedance) running through, over, along, and/or the like, one or more substrates, interposers, bridges, and/or the like. In some embodiments, and depending on the implementation details and/or context, one or more connections (e.g., electrical connections, optical connections, and/or the like) between D2D systems may be referred to as interconnects, channels, interconnect channels, and/or the like.

The transaction layer 102 may implement one or more protocols that may be used to transfer data using the physical layer 106. Examples of protocols that may be implemented by the transaction layer 102 may include Peripheral Component Interconnect Express (PCIe), Compute Express Link (CXL), Advanced extensible Interface (AXI), Coherent Hub Interface (CHI), Cache Coherent Interconnect for Accelerator (CCIX), CCIX Streaming Interface (CXS), and/or the like. Additionally, or alternatively, the transaction layer 102 may implement one or more modes, formats, and/or the like (e.g., a streaming mode, a generic mode, a raw format, and/or the like) that may support one or more user configured (e.g., user defined) protocols.

The link layer 104 may implement one or more of a wide variety of functions, operations, features, and/or the like, in accordance with example embodiments of the disclosure. For example, the link layer 104 may coordinate one or more operations of the transaction layer 102 and/or physical layer 106 to transfer data across one or more links 107 implemented by the physical layer 106. As another example, the link layer 104 may implement a cyclic redundancy check (CRC) to detect errors, and/or a retry mechanism to retransmit data. The link layer 104 may be requested, configured, and/or the like, to implement a CRC and/or a retry mechanism, for example, by a transaction layer 102 and/or an application which, in some embodiments, may implement some or all of a transaction layer 102.

As a further example, the link layer 104 may implement an arbitration (ARB) and/or multiplexing (MUX) function if the link layer 104 is configured to support more than one protocol and/or instances of a protocol (e.g., using one or more protocol stacks). As yet another example, the link layer 104 may implement a scheme to detect link health, for example, by periodically injecting one or more parity bytes into a data stream (e.g., as part of a data transfer operation which, in some embodiments, may be referred to as a runtime operation). Additional examples may include link state management for one or more links 107 that may be implemented by the physical layer 106, parameter negotiation (e.g., between one or more D2D systems 101 and/or one or more components thereof), and/or the like.

The physical layer 106 may include apparatus to implement one or more links 107 between D2D systems and/or between a D2D system and one or more other apparatus (e.g., an off-die apparatus). A link 107 may include a group of one or more lanes. In some embodiments, a link 107 may include a mainband portion (e.g., 16 data lanes (×16 data) or 64 data lanes (×64 data)), and/or a sideband portion (e.g., 2 sideband lanes (×2 sideband)). Some links 107 may be implemented with one or more modules, each of which may include one or more lanes of one or more types (e.g., 16 mainband lanes and 2 sideband lanes per module, 64 mainband lanes and 2 sideband lanes per module, and/or the like). In some embodiments, a link 107 may be characterized as having an N-byte datapath where N may indicate the total number of data lanes in the link 107. For example, a link implemented with four modules having 16 data lanes each may have a 64 byte datapath, and a link implemented with two modules having 64 data lanes each may have a 128 byte datapath.

In some embodiments, the physical layer 106 may be implemented with one or more sublayers, for example, a logical physical layer (logical PHY) and/or an electrical layer which may include, and/or be referred to as, an analog front end (AFE).

An electrical layer may include one or more transmitters, receivers, and/or the like to implement one or more lanes. A lane may be implemented with a transmitter and a receiver, for example, to implement a pair of transmit and receive signals. A transmitter may include one or more components such as a buffer (e.g., a first-in-first-out (FIFO) buffer), a serializer to convert parallel data to serial data, one or more drivers to drive electrical signals on a channel, a deskew circuit, a phase interpolator, clock circuitry (e.g., a clock forwarding circuit), and/or the like. A receiver may include one or more components such as one or more amplifiers and/or sampling circuits such as flip-flops (e.g., to receive data signals, clock signals, and/or the like), a deskew circuit, a buffer, a deserializer, clock circuitry (e.g., phase generation), and/or the like.

A logical physical layer may coordinate, manage, and/or the like, one or more operations (e.g., initialization, sequencing, transmission, reception, and/or the like) of an electrical layer. For example, a logical physical layer may implement byte-to-lane mapping in which data packets may be transmitted in bytes with one or more bytes transmitted on separate lanes (e.g., byte 0 may be transmitted on lane 0, byte 1 may be transmitted on lane 1, and so on). A byte may be transmitted during eight consecutive unit intervals (UIs) such that each bit of a byte may be transmitted on the same lane during a corresponding UI.

FIG. 2 illustrates an embodiment of a bit arrangement within byte transfers on one or more lanes in accordance with example embodiments of the disclosure. In the embodiment illustrated in FIG. 2, data for one byte indicated as B0, B1, . . . may be transferred on a corresponding lane indicated as Lane 0, Lane 1, . . . based on a clock signal and/or a valid signal. Bits 0-7 of byte B0 may be indicated as B0[0], B0[1], . . . . B0[7], respectively. Similarly, bits 0-7 of byte B1 may be indicated as B1[0], B1[1], B1[7], respectively. Each bit transfer may take a UI, and thus, a byte transfer may take 8 UIs. In the example embodiment illustrated in FIG. 2, a byte may be considered a transfer unit, and thus, a transfer interval may be 8 UIs. In other embodiments, however, other transfer units may be used (e.g., 4-bit nibble, a 16-bit word, a 32-bit word, a 64-bit word, and/or the like, that a physical layer may map to a lane).

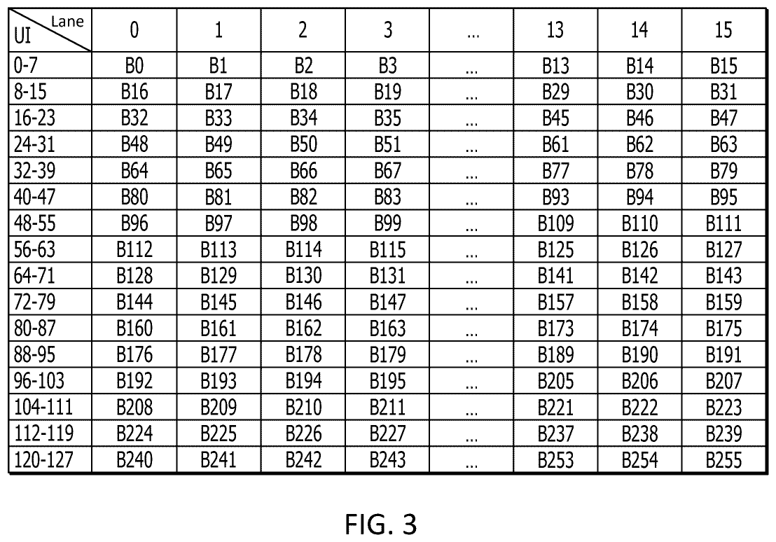

FIG. 3 illustrates an embodiment of a byte-to-lane mapping in accordance with example embodiments of the disclosure. In the example illustrated in FIG. 3, a 256-byte transaction is performed in 16-byte portions, for example, to use a 16-lane (e.g., ×16) module. In some embodiments, an operation in which one byte may be transmitted on each data lane in a link having N data lanes (which may be referred to as an N-lane link) may be referred to as a transfer, a data transfer, or an N-byte transfer (e.g., a 16-byte transfer on a link having 16 data lanes). Thus, in some embodiments, the number of bytes in an N-byte transfer may correspond to the number of lanes in a datapath of the link.

Byte-to-lane mappings other than that illustrated in FIG. 3 may be used. For example, in some embodiments, information may be transferred in any number of bytes per group and/or set of groups may be transferred (e.g., transferred in multiples of any number, not just 256), any number of lanes per link (not just 16, 64, etc.). In some embodiments, a number of bytes per transfer may be different than a number of lanes in a link. Thus, one or more lanes may be unused (e.g., for data) for a transfer of a group of bytes.

Referring again to FIG. 1, as another example of logical physical layer features, a logical physical layer may implement a scrambling and/or descrambling scheme in which a sequence of bits to be transmitted on a lane may be reordered such that the bits are transmitted on the same lane but in a different sequence. For example, referring to FIG. 2, the sequence in which bits B0[0], B0[1], . . . . B0[7] are transmitted may be reordered, but the bits within byte 0 are still transmitted on lane 0. A bit sequence for a lane may be reordered, for example, using a linear feedback shift register (LFSR). In some embodiments, each lane may use a separate LFSR and a different seed value to reorder the sequence of bits for the lane.

Further examples of functions that may be performed by a logical physical layer may include coordinating a link state machine and/or initialization, coordinating protocol options and/or parameter exchanges (e.g., with another D2D system (remote link partner) at the other end of a link), link training, lane repair, lane reversal, sideband initialization and/or transfers, and/or the like.

The link layer interface 103 may be implemented, for example, with one or more signals (e.g., digital electrical signals) that may facilitate transfer of information between the transaction layer 102 and the link layer 104. Examples of signals used by the link layer interface 103 may include one or more (e.g., 8, 16, 32, etc.) data signals to transfer data from the transaction layer 102 to the link layer 104, one or more (e.g., 8, 16, 32, etc.) data signals to transfer data from the link layer 104 to the transaction layer 102, one or more clock signals that may be used to clock one or more (e.g., all) other signals, one or more signals to implement a sideband interface, and/or one or more signals to perform functions such as configuration, control, status, and/or the like, for the link layer interface 103. Examples of configuration functions may include a stream identifier (stream ID) that may be used for data transfers to and/or from the link layer 104, a number of data signals used by the link layer interface 103, a link speed, and/or the like. In some embodiments, a stream ID may map to a stack and/or a protocol (e.g., PCIe, CXL.io, CXL.cache, CXL.mem, CXL.cachemem, a streaming protocol, a raw format, and/or the like). Examples of control functions may include requesting a state change, requesting a data transfer, and/or the like. Examples of status functions may include indicating a state of the link layer interface 103, indicating data is available, indicating a negotiated protocol, indicating that a link 107 may be training, indicating an error, and/or the like.

The physical layer interface 105 may be implemented, for example, with one or more signals (e.g., digital electrical signals) that may facilitate transfer of information between the link layer 104 and the physical layer 106. Examples of signals used by the physical layer interface 105 may include one or more (e.g., 8, 16, 32, etc.) data signals to transfer data from the link layer 104 to the physical layer 106, one or more (e.g., 8, 16, 32, etc.) data signals to transfer data from the physical layer 106 to the link layer 104, one or more clock signals that may be used to clock one or more (e.g., all) other signals, and/or one or more signals to perform functions such as configuration, control, status, and/or the like, for the physical layer interface 105. Examples of configuration functions may include a number of data signals used by the physical layer interface 105, a link speed, and/or the like. Examples of control functions may include requesting a state change, requesting a data transfer, and/or the like. Examples of status functions may include indicating a state of the physical layer interface 105, indicating data is available, indicating an error, and/or the like.

In some embodiments, the physical layer interface 105 may be characterized as a raw interface, raw die-to-die interface, and/or the like. For example, depending on the implementation details, the physical layer interface 105 may be used to implement a raw format for transfers from the transaction layer 104 to the physical layer 106. In some embodiments, the physical layer interface 105 may be implemented at least partially using a state machine that may be queried, controlled, configured, reset, and/or the like, using one or more of the signals described above. In some embodiments, raw may mean the physical layer interface 105 may cause the physical layer 106 to send (e.g., per transfer) whatever N bytes the link layer 104 passes through the interface 105 without regard to what is in the N bytes. Additionally, or alternatively, the link layer 104 may use a byte-to-lane mapping implemented by the physical layer 106 which the link layer 104 may not have knowledge of (other than to know that each byte is sent using a separate lane).

In some embodiments, one or more components of the D2D system illustrated in FIG. 1 (e.g., a link layer 104, and/or a physical layer 106) may be used to implement, replace, and/or the like, one or more portions of a protocol. For example, in some embodiments, some or all of a link layer 104 and/or a physical layer 106 may be used to replace some or all of a serializer/deserializer (SERDES or SerDes) portion of a physical layer of a PCIe protocol and/or some or all of a logical physical (LogPHY) portion of a physical layer of a PCIe protocol and/or a CXL protocol. Depending on the implementation details, such a configuration may improve the performance (e.g., bandwidth, latency, power efficiency, and/or the like), cost, and/or the like of the protocol.

In some embodiments, one or more components of the D2D system 101, and/or one or more portions thereof, may be configured to operate, at least partially, on the basis of one or more modes, operation formats, (e.g., a raw format, a flow control unit (flit) format, and/or the like), or combinations thereof.

A mode may be based, for example, on a protocol implemented by the transaction layer 102. Examples of modes may include a PCIe flit mode, a PCIe non-flit mode, a CXL 68-byte (68B) flit mode, a CXL 256-byte (256B) flit mode, a streaming mode (which may also be referred to as a streaming protocol), and/or the like.

An operation format may be based, for example, on a technique that the link layer 104 may use to arrange (e.g., rearrange) data information received from the transaction layer 102 into one or more transfers (e.g., N-byte transfers) that the link layer 104 send to the physical layer 106 (e.g., using the physical layer interface 105) for transmission over a datapath of a link 107. Examples of operation formats may include a raw format, a 68B flit format, a 256B flit format, and/or the like.

Some modes may be used (e.g., implemented) with one or more operation formats. For example, a CXL 68B flit mode may be used with (in some implementations may only be used with) a 68B flit format, whereas a streaming mode may operate with a raw format, a 68B flit format, a 256B flit format, and/or the like.

In some embodiments, a mode, an operation format, or a combination thereof, may implement an error detection mechanism, a retry mechanism, and/or the like, at a transaction layer 102, a link layer 104, or a combination thereof. For example, some protocols may implement an error detection mechanism and/or a retry mechanism at the transaction layer 102 and thus may not rely on an error detection mechanism and/or a retry mechanism at the link layer 104. As another example, some protocols may rely on an error detection mechanism and/or a retry mechanism at the link layer 104 and thus may not implement an error detection mechanism and/or a retry mechanism at the transaction layer 102. As a further example, in some embodiments, a first error detection mechanism and/or retry mechanism may be implemented at the transaction layer 102, and a second (e.g., independent) error detection mechanism and/or retry mechanism may be implemented at the link layer 104.

In a first example configuration of a protocol mode and operation format, a transaction layer 102 and a link layer 104 may be configured to implement a protocol using a 256B flit format (e.g., a PCIe flit mode, a CXL 256B flit mode, and/or the like). In such a configuration, the link layer 104 may receive one or more data bytes from the transaction layer 102, calculate a check code (e.g., a CRC code) for the data bytes, and arrange the data bytes, the check code, one or more header bytes, and/or the like, into one or more groups of bytes that may be transferred to the physical layer 106 for transmission on a link 107. In some embodiments, a group of bytes may include a number of bytes corresponding to the number of bytes in a datapath of the link 107. A link layer of another D2D system at another end of the link 107 (e.g., a remote link partner) may receive the groups of bytes, use the check code to check the data bytes for errors and, based on a successful transmission, transfer the data bytes to a transaction layer at the other D2D system. In some embodiments, a check code calculation may also include one or more header bytes and/or other types of information in addition to some or all of the data bytes.

In the first example configuration, the link layer 104 may additionally, or alternatively, implement a retry mechanism. For example, the link layer 104 may include retry logic having a retry buffer that may store information (e.g., one or more flits, one or more groups of bytes, and/or the like) that have been transferred to the physical layer 106 for transmission on a link 107. The retry logic may resend information stored in a retry buffer based, for example, on receiving a retry message from a link layer of another D2D system at another end of the link 107. A retry message may be based, for example, on an error detected at the receiving link layer.

In a second example configuration of a protocol mode and operation format, a transaction layer 102 and a link layer 104 may be configured to implement a streaming protocol using a raw format. In such a configuration, the link layer 104 may receive one or more data bytes from the transaction layer 102 and transfer the data bytes to the physical layer 106 with little or no modification. For example, in some embodiments, the link layer 104 may allow the transaction layer 102 to directly populate one or more groups of bytes that may be transferred to the physical layer 106 for transmission on a link 107. In such a configuration, the transaction layer 102 may implement an error detection mechanism, a retry mechanism, and/or the like, if any.

FIG. 4 illustrates an embodiment of an interface architecture for a D2D system in accordance with example embodiments of the disclosure. The embodiment illustrated in FIG. 4 may include a first D2D system 401T and a second D2D system 401R connected with one or more links 407. The first D2D system 401T may be located at a first die 408, the second D2D system 401R may be located at a second die 409, and the one or more links 407 may be implemented, for example, using one or more conductors in and/or on one or more substrates, interposers, bridges, and/or the like. Either or both of the first die 408 and/or the second die 409 may be implemented with one or more dies (chips), dielets (chiplets), and/or any other type of integrated circuit device.

For purposes of illustration, the first D2D system 401T and the second D2D system 401R may be configured and/or operate as a transmit (TX) D2D system and a receive (RX) D2D system, respectively. However, either or both of the first D2D system 401T and second D2D system 401R may be capable of transmitting and/or receiving data across one or more links 407.

The first D2D system 401T (which may also be referred to as a transmit D2D system or a transmit interface) may include a transaction layer 402T, a link layer 404T, and/or a physical layer 406T. The transaction layer 402T and the link layer 404T may communicate using a link layer interface 403T. The link layer 404T and the physical layer 406T may communicate using a physical layer interface 405T.

The receive D2D system 401R (which may also be referred to as a receive D2D system or a receive interface) may include a transaction layer 402R, a link Jayer 404R, and/or a physical layer 406R. The transaction layer 402R and the link layer 404R may communicate using a link layer interface 403R. The link layer 404R and the physical layer 406R may communicate using a physical layer interface 405R.

The transaction layer 402T at the transmit interface 401T and/or the transaction layer 402R at the receive interface 401R may implement one or more protocols and/or modes thereof. In the example illustrated in FIG. 4, the transaction layer 402T may implement a first streaming protocol 416T-0 indicated as Streaming 0, for example, with a first on-die (OD) interface port OD0 (e.g., an AXI port), a second streaming protocol 416T-1 indicated as Streaming 1, for example, with a second OD interface port OD1 (e.g., a CHI port), and/or a third streaming protocol 416T-2 indicated as Streaming 2, for example, with a third OD interface port OD2 (e.g., a CXS port). Additionally, or alternatively, the transaction layer 402T may implement a protocol 416T-3 that may implement, or be implemented with, a protocol transaction layer (e.g., PCIe, CXL, and/or the like) that may send and/or receive transaction layer packets (TLPs). One or more of the protocols 416T-0, 416T-1, 416T-2, and/or 416T-3 (which may be referred to individually and/or collectively as 416T) may be implemented with one or more corresponding stacks (e.g., one or more hardware and/or software stacks), for example, a stack per protocol. In some embodiments, one or more of the protocols 416T may implement a protocol layer with an interface, e.g., to access the protocol.

In some embodiments, the link layer 404T may include multiplexing logic 420 (which may include arbitration logic), retry logic 417, CRC logic 418, and/or parity logic 419.

The arbitration and/or multiplexing logic 420 may be configured to multiplex two or more protocols, two or more protocol stacks, two or more protocols within a stack, and/or the like, onto a physical layer 406T, a link 407, and/or the like. For example, in some embodiments, and depending on the implementation details, arbitration and/or multiplexing logic 420 may multiplex two or more protocols, two or more protocol stacks, two or more protocols within a stack, and/or the like, onto a physical layer 406T, a link 407, and/or the like, such that they may share the bandwidth of a link 407.

The retry logic 417 may implement a retry scheme in which the link layer 404T may store information for retransmission (e.g., one or more flits or portions thereof, groups of bytes, and/or the like) that has been transferred to the physical layer 406T for transmission on a link 407. The retry logic 417 may include a retry buffer 421 to store information for retransmission and/or retry multiplexer 422 that may switch between sending information on a first try (e.g., from the arbitration and/or multiplexing logic 420) and resending information from the retry buffer 421. The retry logic 417 may resend information (e.g., one or more flits or portions thereof, groups of bytes, and/or the like) based, for example, on receiving a retry message from a link layer of another D2D system at another end of the link 407. A retry message may be based, for example, on an error detection (e.g., using CRC information) at the receiving link layer.

A retry scheme may be selected and/or enabled by a protocol 416T, by the link layer 404T, or a combination thereof. In some embodiments, the retry scheme may be enabled automatically based on the protocol 416T and/or an operation format configuration. For example, in some embodiments, the retry scheme may be automatically enabled when the transaction layer 402T and/or link layer 404T are configured to use a protocol in a flit mode using a flit format. As another example, the retry scheme may be automatically disabled when the transaction layer 402T and/or link layer 404T are configured to use a raw format.

The CRC logic 418 may include functionality to insert error detection information in one or more flits or portions thereof, groups of bytes, sets of groups of bytes, and/or the like. For example, CRC logic 418 may include a CRC generator polynomial circuit configured to generate a CRC code that may be inserted in one or more flits or portions thereof, groups of bytes, and/or the like, that may be transmitted from the physical layer 406T to the physical layer 406R.

The parity logic 419 may include functionality to insert parity information in one or more flits or portions thereof, groups of bytes, sets of groups of bytes, and/or the like, when applicable. For example, parity logic 419 may be used to insert parity information when the transaction layer 402T implements a specific protocol that uses a parity scheme. The parity logic 419 may include a multiplexer 425 that may be used to insert parity information generated by a parity generator 424 into data that may be transferred from the link layer 404T to the physical layer 406T for transmission on a link 407.

The physical layer 406T may include apparatus to implement a link 407 between the transmit D2D system 401T and the receive D2D system 401R. The physical layer 406T may implement any of the structure, functionality, and/or the like described above with respect to the embodiment illustrated in FIG. 1 including a group of one or more lanes that may have a mainband portion (e.g., one or more data lanes) and/or a sideband portion (e.g., one or more sideband lanes), any or all of which may be implemented as modules, one or more sublayers (e.g., a logical physical layer, an electrical layer, and/or the like), an analog front end, one or more transmitters, receivers, and/or the like, using any byte-to-lane mapping such as those described above.

One or more components of the receive D2D system 401R may implement a receive version of transmit functionality that may be implemented by the transmit D2D system 401T. As one example, the physical layer 406R may receive information on one or more lanes of the link 407 in the form of bits during eight consecutive UIs which may be deserialized into a byte and transferred to a link layer 404R based on a byte-to-lane mapping as illustrated in FIG. 3.

As another example, the link layer 404R may include parity check logic 426 that may use the parity information generated by the parity generator 424 in the parity logic 419 to detect one or more errors in data that may be transferred from the link layer 404T to the physical layer 406T for transmission on a link 407.

As a further example, the link layer 404R may include CRC check logic 427 that may use error detection information generated by the CRC logic 418 and inserted in one or more flits, groups of bytes, set of groups of bytes, and/or the like, to check for errors in information received at the second D2D system 401R. In some embodiments, the CRC check logic 427 may use a result of an error detection operation to initiate a retry operation. For example, the CRC check logic 427 may use detection information such as one or more of bytes CRC0 through CRC3 to detect an error in one or more of a header byte, data byte, and/or the like, in a flit format described herein. Based on detecting an error, the CRC check logic 427 may send a retry request to the retry logic 417 the link layer 404T to request retransmission of a flit, group of bytes, set of groups of bytes, and/or the like, for example, using a sequence number to identify the information to be retransmitted.

As an additional example, the link layer 404R may include arbitration and/or demultiplexing logic 428 that may be configured to demultiplex, from a link 407, back to their individual forms, two or more protocols, two or more protocol stacks, two or more protocols within a stack, and/or the like, that may have been multiplexed onto the link 407 by the arbitration and/or multiplexing logic 420 at the transmit D2D system 401T.

As yet another example, the transaction layer 402R at the receive D2D system 401R may implement one or more protocols 416R-0, 416R-1, 416R-2, and/or 416R-3 corresponding to one or more protocols 416T-0, 416T-1, 416T-2, 416T-3, respectively, implemented at the transaction layer 402T at the transmit D2D system 401T. Specifically, a first streaming protocol 416R-0 indicated as Streaming 0 may be implemented, for example, with an AXI port, a second streaming protocol 416R-1 indicated as Streaming 1 may be implemented, for example, with a CHI port, and/or a third streaming protocol 416R-2 indicated as Streaming 2 may be implemented, for example, with a CXS port. Additionally, or alternatively, the transaction layer 402R may implement a protocol 416R-3 that may implement, or be implemented with, a transaction layer (e.g., PCIe, CXL, and/or the like) that may send and/or receive TLPs.

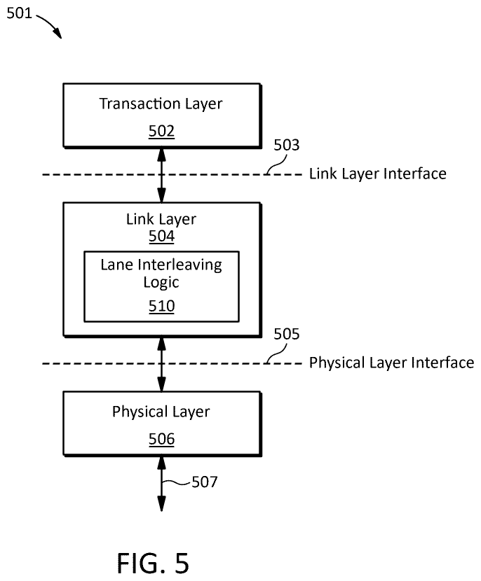

FIG. 5 illustrates an embodiment of a D2D system with a lane interleaving scheme in accordance with example embodiments of the disclosure. The embodiment illustrated in FIG. 5 may include one or more elements that may be similar to those illustrated in other figures, including FIG. 1, in which similar elements may be indicated by reference numbers ending in, and/or containing, the same digits, letters, and/or the like.

The D2D system 501 illustrated in FIG. 5 may include a link layer 504 that may communicate with a transaction layer 502 using a link layer interface 503 and/or with a physical layer 506 using a physical layer interface 505.

The link layer 504 may include lane interleaving logic 510 that may implement a lane interleaving scheme in accordance with example embodiments of the disclosure. For example, in an embodiment in which a physical layer 506 may implement a byte-to-lane mapping in which a first byte of a transaction may be transmitted using a first lane and a second byte of the transaction may be transmitted using a second lane, the lane interleaving logic 510 may rearrange one or more portions of the first byte and/or one or more portions of the second byte such that a portion of the first byte and a portion of the second byte may be transmitted using the same lane. Thus, portions of bytes mapped to separate lanes may be transmitted using the same lane. The lane on which the portion of the first byte and the portion of the second byte are transmitted on may or may not be one of the first lane or the second lane. For example, the portion of the first byte and the portion of the second byte may be transmitted using a third lane.

Additionally, or alternatively, the lane interleaving logic 510 may rearrange one or more portions of the first byte such that a first portion of the first byte may be transmitted using a first lane and a second portion of the first byte may be transmitted using a second lane. Thus, portions of a byte mapped to one lane may be transmitted using different lanes.

In some embodiments, an instance of the D2D system 501 illustrated in FIG. 5 may be implemented at a first die, and a second instance of the D2D system 501, but having deinterleaving logic, may be implemented at a second die that may communicate with the first instance of the D2D system 501. The deinterleaving logic may rearrange one or more portions of first and/or second bytes to their original arrangements.

Depending on the implementation details, a lane interleaving scheme in accordance with example embodiments of the disclosure may improve one or more of a BER, an effective BER, a bandwidth, a latency, a power consumption, and/or the like. For example, in some embodiments, lane interleaving logic 510 may implement bit interleaving (or sub-byte interleaving) that may transform a pattern of burst errors that may occur on one lane to a pattern of random errors (which may also refer to an error pattern that may resemble a random error pattern, e.g., quasi-random error pattern), spread across multiple lanes. This may enable the errors to be detected and/or corrected, at least in part, using one or more error detection and/or correction techniques that may otherwise be ineffective or less effective at correcting burst errors. For example, in some embodiments, one or more convolutional codes, turbo codes, low-density parity-check (LDPC) codes, linear block codes, and/or the like, may be used to detect and/or correct one or more errors in one or more bytes spread across multiple lanes.

In some embodiments, and depending on the implementation details, a byte may refer to any unit of data that a physical layer may map to a lane. Thus, a byte may refer to an 8-bit byte (which may also be referred to as an octet), a 4-bit nibble, a 16-bit word, a 32-bit word, a 64-bit word, and/or the like, that a physical layer may map to a lane.

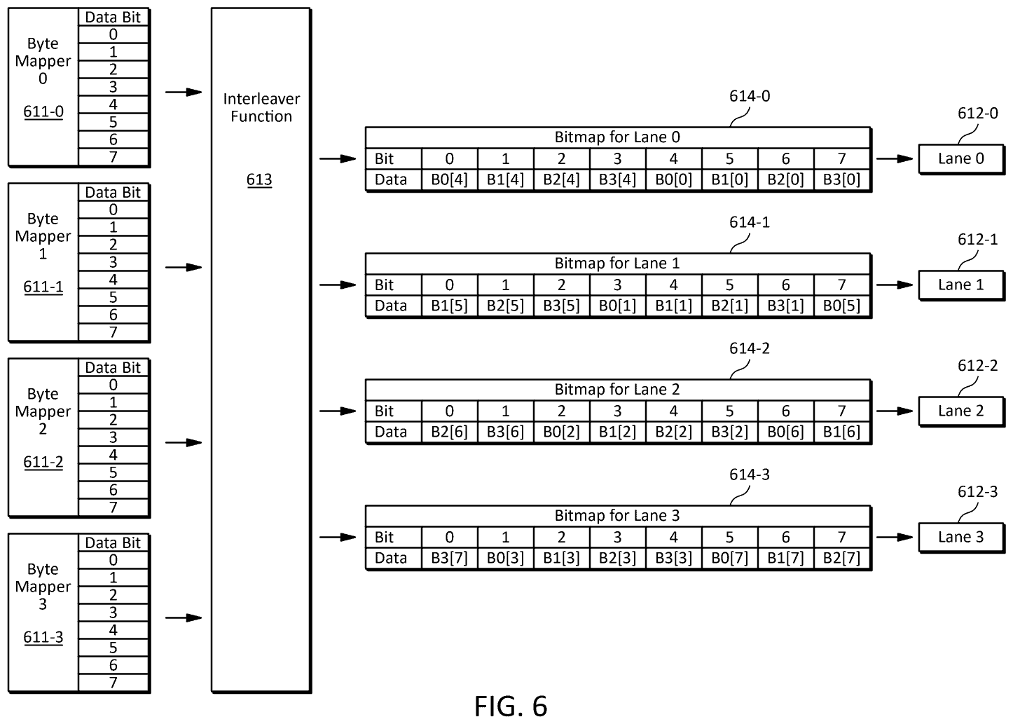

FIG. 6 illustrates an embodiment of an interleaving scheme in accordance with example embodiments of the disclosure. The embodiment illustrated in FIG. 6 may be implemented with, or used to implement, for example, the lane interleaving logic 510 illustrated in FIG. 5 and/or any other interleaving scheme disclosed herein.

In the embodiment illustrated in FIG. 6, four byte mappers 611-0, 611-1, 611-2, and/or 611-3 may map bytes to lanes 612-0, 612-1, 612-2, and/or 612-3, respectively. The bits of each byte of the byte mappers 611 may be arranged within in the order 0-7 as illustrated in FIG. 6. For example, bits 0-7 of byte mapper 611-0 may be indicated as B0[0], B0[1], . . . . B0[7], respectively. Similarly, bits 0-7 of byte mapper 611-1 may be indicated as B1[0], B1[1], . . . . B1[7], respectively.

Lanes 612 may be implemented, for example, as part of any D2D link disclosed herein such as link 107 illustrated in FIG. 1 and/or link 407 illustrated in FIG. 4.

In some embodiments, having byte mapper 611-0 mapped to lane 612-0 may mean that a physical layer may receive a byte from byte mapper 611-0 through a physical layer interface and transmit the bits of the byte from byte mapper 611-0 on lane 612-0, for example, in the sequence shown in the bit arrangement within a byte transfer as illustrated in FIG. 2.

In the interleaving scheme illustrated in FIG. 6, however, bytes from the byte mappers 611 may be input to an interleaving function 613 that may generate remapped bytes 614-0, 614-1, 614-2, and/or 614-3 having revised bitmaps as illustrated in FIG. 6. For example, bits 0 and 4 from byte mappers 611-0, 611-1, 611-2, and/or 611-3 may be combined in remapped byte 614-0. Similarly, bits 1 and 5 may be combined in remapped byte 614-1.

Any type of interleaving function 613 may be used, for example, a random or pseudo-random sequence generator, a linear feedback shift register (LFSR), a polynomial, and/or the like. In some example embodiments, the interleaving function 613 may be implemented as follows:

$$π ( x ) = a mod number of lanes \qquad ( Eq . 1 )$$

$$and$$

$$π ( y ) = number of Mappers - y + Mapper index \qquad ( Eq . 2 )$$

where α represents an index (e.g., a memory index), π(x) represents a lane selection decision, and π(y) represents a bit location decision within a lane, the Mapper index may be an index based on a lane (e.g., a logical physical layer may have multiple mappers), and y represents an index. If the result π(y) of Eq. 2 is negative, π(y)+8 may be used as the final result.

The remapped bytes 614 may be transferred by a physical layer over corresponding lanes 612 to another die where a D2D system may implement a deinterleaving function that may restore the interleaved bits to their original arrangements in the byte mappers 611.

Referring to remapped byte 614-0, if a burst error occurs on lane 0 during the transfer of remapped byte 614-0 on lane 612-0, the individual bit errors may be spread across bits from four different bytes (e.g., bits 0 and/or 4 of mappers 611-0, 611-1, 611-2, and/or 611-3. Thus, when the individual bits are restored to their original bytes, the bits of the burst error may be spread across four different bytes. Depending on the implementation details, this may enable an error correction scheme to correct the individual bit errors that may otherwise be difficult to correct as a burst error on a single byte.

In some embodiments, an interleaving function 613 may be implemented with little or no contention. For example, with some contention-free implementations, there may be no duplication of sent data (e.g., there may be no duplication of lanes until the interleaving has gone through all of the lanes). In some embodiments, repeating sent data and/or lanes may cause contention.

For purposes of illustration, the embodiment illustrated in FIG. 6 is shown with four byte mappers 611 and four lanes 612, but any number of byte mappers and/or any number of lanes may be used.

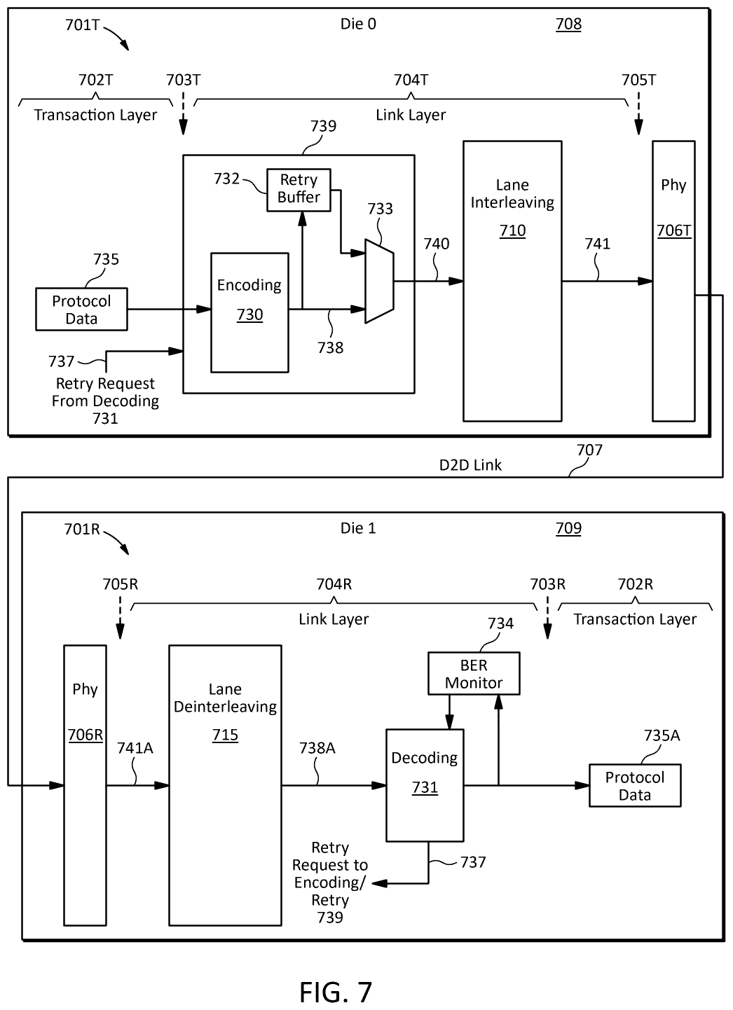

FIG. 7 illustrates an embodiment of an interface architecture for a D2D system having interleaving and error correction in accordance with example embodiments of the disclosure. The embodiment illustrated in FIG. 7 may include one or more elements that may be similar to those illustrated in other figures, including FIGS. 4 and 5, in which similar elements may be indicated by reference numbers ending in, and/or containing, the same digits, letters, and/or the like.

In the embodiment illustrated in FIG. 7, a first D2D system 701T on a first die 708 may include a link layer 704T having lane interleaving logic 710, encoding logic 730, a retry buffer 732, and/or a retry multiplexer 733. A second D2D system on a second die 709 may include lane deinterleaving logic 715, lane decoding logic 731, and/or a BER monitor 734.

The encoding logic 730 may implement an error correction scheme to encode protocol data 735 received from a transaction layer 702T to generate encoded information 738 which, in some embodiments, may include parity information. The encoding logic 730 is not limited to any specific coding schemes. However, in some embodiments, it may be beneficial to use any type of coding in which a coding rate may be modified. For example, some error correction codes may have a base coding rate or a mother coding rate that may be modified (e.g., using a puncturing method) to provide an effective coding rate, an actual coding rate, and/or the like. Some examples may include convolutional codes, turbo codes, trellis codes, Hamming codes, Reed-Solomon (RS) codes, LDPC codes, linear block codes, and/or the like.

The retry buffer 732 may store protocol data 735, error correction information (e.g., parity information) for protocol data 735, encoded information 738 (which may include encoded versions of protocol data 735 and/or error correction information), and/or the like. The retry multiplexer 733 may select an output of the encoding logic 730 and/or an output of the retry buffer 732 to provide input information 740 (e.g., e.g., one or more flits or portions thereof, bytes, groups of bytes, streams of bytes, and/or the like) to the lane interleaving logic 710.

At the receiving D2D system 701R, the lane decoding logic 731 may use error correction information in the encoded information 738A arriving at the lane decoding logic 731 to correct one or more errors that may have occurred in the data information as it was transmitted from the first die 708 to the second die 709 (e.g., in one or both of the physical layers 706, the link 707, and/or the like). Examples of decoding techniques may include a Viterbi algorithm (which may decode, for example, information encoded with a convolutional code, a trellis code, and/or the like), a Fano algorithm, and/or the like. In some embodiments, if the lane decoding logic 731 is unable to correctly decode the data information in the encoded information 738A (e.g., recover the protocol data 735), the lane decoding logic 731 may send a retry request 737 to the retry multiplexer 733, and/or encoding logic 730.

In some embodiments, the retry buffer 732, retry multiplexer 733, and/or encoding logic 730 may implement an encoding and/or retry scheme 739 with a retry feature in which, in response to receiving a retry request signal 737 from a receiving D2D system 701R, less than all of the encoded information 738 may be retransmitted. For example, in some embodiments, the encoding logic 730 may implement an error correction code that generates multiple portions of parity information for a specific amount of data information. Rather than retransmitting the entire encoded information 738, the encoding and/or retry scheme 739 may only send a first portion of the parity information in response to a retry request 737. Depending on the implementation details, this may enable the lane decoding logic 731 at the receiving D2D system 701R to correctly decode the data information while reducing the amount of error correction information transferred by the link 707.

The lane interleaving logic 710 may implement an interleaving scheme in which the link layer 704T may rearrange information within bytes mapped to one or more lanes of a link 707. In some embodiments, the lane interleaving logic 710 may implement an interleaving scheme such as that illustrated and described with respect to FIG. 6. For example, the lane interleaving logic 710 may rearrange information in the input information 740 to generate interleaved information 741 (e.g., bytes having remapped bits) that may cause bits of a byte mapped to a specific lane of link 707 to be spread across more than lane. Additionally, or alternatively, the interleaved information 741 may cause bits of multiple bytes mapped to multiple lanes to be transmitted on one lane of link 707.

At the receiving D2D system 701R, lane deinterleaving logic 715 may apply a reverse interleaving function to the interleaved information 741A arriving at the deinterleaving logic 715. In some embodiments, the interleaved information 741A may be the same as the interleaved information 741 applied to the lane interleaving logic 710 but possibly including one or more errors (e.g., introduced by one or both of the physical layers 706, the link 707, and/or the like.). However, in the deinterleaved information 738A output from the lane deinterleaving logic 715 one or more burst errors (if any) that may have been concentrated in a byte mapped to a lane may have been transformed to one or more random errors spread across multiple bytes mapped to multiple lanes. Depending on the implementation details, this may enable the architecture illustrated in FIG. 7 to correct more errors and therefore improve the overall BER of the D2D systems 701.

In some embodiments, the link layer 704R at the receiving D2D system 701R may include a BER monitor 734 that may monitor errors in the recovered protocol data 735 and/or provide feedback information to one or more components such as the lane decoding logic 731, encoding and/or retry scheme 739, and/or the like. For example, if the BER monitor 734 detects an increase in the BER and/or a reduction in throughput caused by an increase in retry requests, the BER monitor 734 may send a request (e.g., through the lane decoding logic 731) to the encoding and/or retry scheme 739 to increase a data coding rate used with an encoding scheme. This may be accomplished, for example, by increasing an amount of error correction information (e.g., parity information) sent with a first transmission attempt.

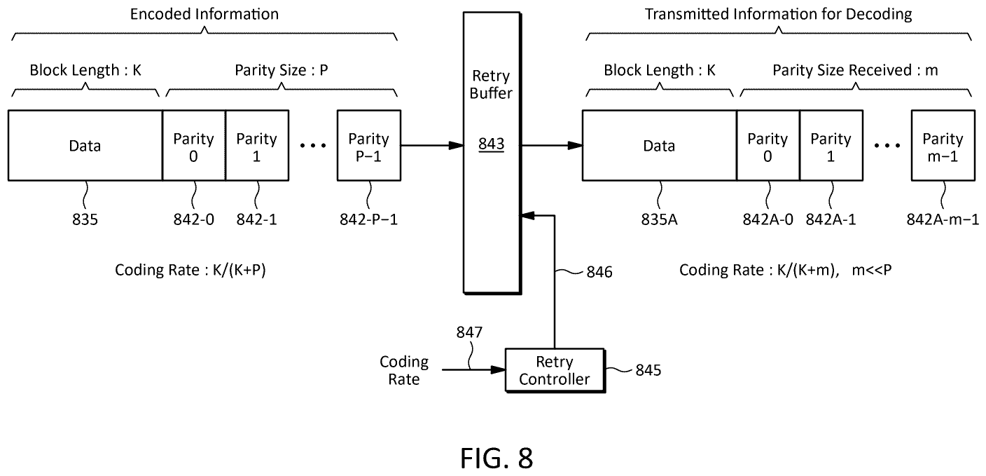

FIG. 8 illustrates an embodiment of a retry scheme for a D2D system having error correction in accordance with example embodiments of the disclosure. The embodiment illustrated in FIG. 8 may be used to implement, and/or may be implemented with, any of the error correction and/or retry schemes for D2D systems disclosed herein, including, for example, the encoding and/or retry scheme 739 and/or decoding logic 731 illustrated in FIG. 7.

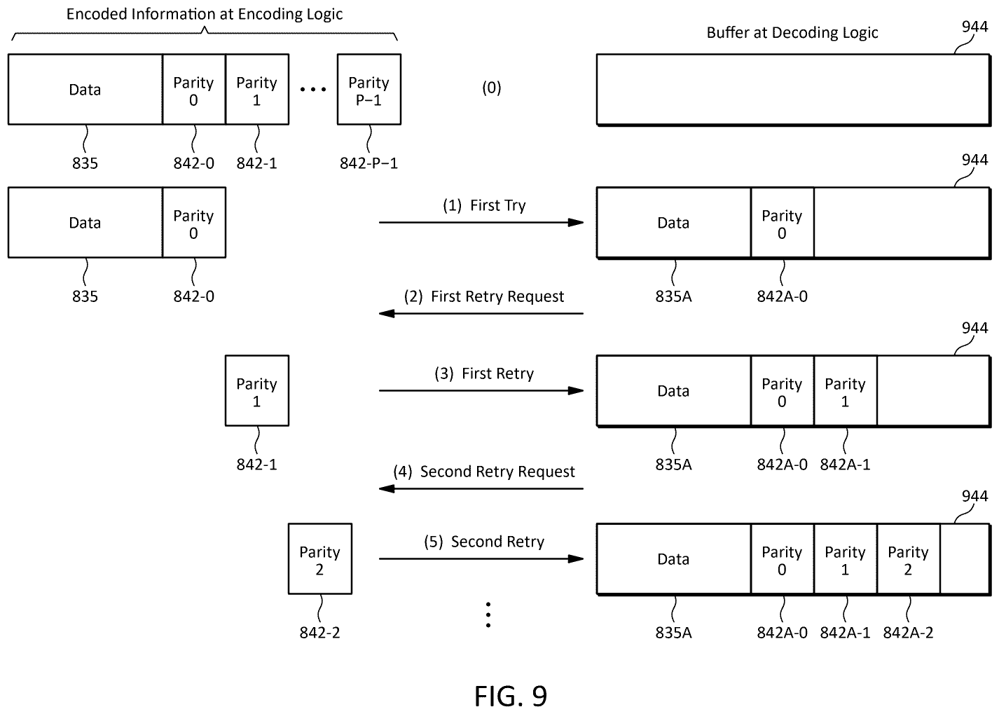

FIG. 9 illustrates an example embodiment of one or more operations of a buffer for a retry operation in accordance with example embodiments of the disclosure. The embodiment illustrated in FIG. 9 may be used, for example, with the embodiment of a retry scheme illustrated in FIG. 8.

Referring to FIGS. 8 and 9, an error correction coding algorithm may be used to generate one or more portions of parity information Parity 0, Parity 1 . . . . Parity P-1 for data information 835 having a size K (which may be referred to as a block size or block length). The data information 835 may be received, for example, from a transaction layer 702T. The portions of parity information Parity 0, Parity 1, . . . . Parity P-1 (which may be indicated as 842-0, 842-1, . . . 842-P-1, respectively) may be referred to collectively as parity information 842 having a size P and may be generated, for example, by encoding logic 730. For purposes of illustration, the embodiments illustrated in FIG. 8 and FIG. 9 may use a convolutional code, but other coding algorithms may be used.

The number and/or sizes of the portions of parity information may be determined, for example, based on a target BER, an expected amount of noise or other sources of errors in one or more physical layers, links, and/or the like, one or more of a target bandwidth, coding overhead, coding rate, and/or the like, for the D2D system. In some embodiments, the number and/or sizes of the portions of parity information may be based on one or more tradeoffs. For example, in some embodiments, increasing the sizes of the portions of parity information may reduce a number of retry requests but increase error correction overhead.

Referring to FIG. 8, the data information 835A and/or portions of parity information Parity-0, Parity 1, . . . . Parity m-1 (which may be indicated as 842A-0, 842A-1, . . . 842A-P-1, respectively) may be referred to collectively as parity information 842A having a size m. The data information 835 and/or parity information 842 may be transmitted, for example, from D2D system 701T to D2D system 701R where it may arrive as data information 835A and/or parity information 842A, either or both of which may possibly include one or more errors.

In some embodiments, the parity information 842A may accumulate gradually (e.g., in a buffer at decoding logic 731 at D2D system 701R), for example, by being transmitted incrementally based on one or more retry requests.

Referring to FIG. 9, at operation (0), a buffer 944 at decoding logic 731 may initially be empty. Encoding logic 730 may generate parity information 842 (including Parity 0, Parity 1, . . . . Parity P-1) having size P for data information 835 and place the data information 835 and/or parity information 842 in a retry buffer 843. At operation (1) encoding logic 730 may send, as a first transmission try, the data information 835 and a first portion 842-0 (Parity 0) of the parity information to the decoding logic 731 where it may arrive as data information 835A and parity information 842A-0 (either or both of which may possibly include one or more errors) and be placed in buffer 944.

If the decoding logic 731 successfully decodes the data information 835A using parity information 842A-0, the retry operation may end. If, however, the decoding logic 731 is not able to decode the data information 835A, the decoding logic 731 may send, at operation (2), a first retry request to the encoding logic 730. At operation (3), the encoding logic 730 may respond to the first retry request by sending a second portion 842-1 (Parity 1) of the parity information to the decoding logic 731 where it may arrive as parity information 842A-1 (possibly with one or more errors) and be placed in the buffer 944.

If the additional portion of parity information 842-1 enables the decoding logic 731 to decode the data information 835A, the retry operation may end. If, however, the decoding logic 731 is not able to decode the data information 835A using the first and second portions of parity information 842A-0 and 842A-1, the decoding logic 731 may send, at operation (4), a second retry request to the encoding logic 730. At operation (5), the encoding logic 730 may respond to the second retry request by sending a third portion 842-2 (Parity 2) of the parity information to the decoding logic 731 where it may arrive as parity information 842A-2 (possibly with one or more errors) and be placed in the buffer 944.

In some embodiments, the process illustrated in FIG. 9 may continue, for example, until the decoding logic 731 is able to decode the data information 835A and/or until all of the information 842 having a size P is sent to the decoding logic 731. In some embodiments, if the decoding logic 731 is still unable to decode the data information 835A after all of the parity information 842 is sent, the retry process may begin again at operation (0).

Referring to FIG. 8, the retry buffer 843 may be used to store some or all of the data information 835 and/or parity information 842 for one or more retry operations. In some embodiments, the retry scheme illustrated in FIG. 8 may include a retry controller 845 that may control access to the retry buffer 843. For example, the retry controller 845 may provide a read address, address pointer, and/or the like, 846 to access the retry buffer 843. In some embodiments, the retry controller 845 may be implemented as a cycle controller or iterative controller because it may cycle or iterate through buffer addresses, retry operations, and/or the like.

In some embodiments, a coding rate (e.g., a maximum coding rate, an available coding rate, and/or the like) may be determined by the size K (which may be referred to as a block size or block length) of the data information 835 and/or the size P of the parity information 842. For example, in some embodiments, a coding rate (e.g., an available coding rate) may be expressed as K/(K+P).

In some embodiments, an effective coding rate (e.g., an actual coding rate) may be determined by the size K of the data information 835 and/or a size m of the parity information Parity 0, Parity 1 . . . . Parity m-1 (which may be indicated as 842A-0, 842A-1, . . . 842A-m-1, respectively) transmitted to a receiving D2D system. For example, in some embodiments, an effective coding rate (e.g., an actual coding rate) may be expressed as K/(K+m), for example, with m<<P.

In some embodiments, an amount of transmitted parity information m may be less than an amount of generated parity information P. This may be especially true, for example, using relatively powerful error coding such as a convolutional code which may enable a decoder to successfully correct one or more errors in data information using a relatively small amount of parity information, and thus, only a relatively small number of portions of the parity information 842 and/or retries may be used. Depending on the implementation details, this may improve the performance of a D2D system, for example, by providing error correction with relatively low coding overhead.

In some embodiments, the use of error coding with a variable coding rate (e.g., a convolutional code) may be beneficial, for example, because data information 835A may be decoded using a variable number of portions of parity information 842A-0, 842A-1, . . . 842A-m-1.

In some embodiments, the parity information 842 may not be calculated at the beginning of a transmission and/or retry operation, but instead, one or more portions of the parity information 842-0, 842-1 . . . 842-P-1 may be calculated (e.g., as needed) as a retry operation progresses.

In some embodiments, encoding logic 730 may send more or less than one additional portion of parity information 842-0, 842-1, . . . 842-P-1 based on receiving a retry request. For example, in some embodiments, encoding logic 730 may adaptively send more than one additional portion of parity information 842-0, 842-1, . . . 842-P-1 in response to a retry request, for example, based on information included in the retry request, information provided by a BER monitor 734, and/or the like.

In some embodiments, a first transmission of the data information 835 may not include any parity information (e.g., the first portion of parity information 842-0). Instead, the first portion of parity information 842-0 may be sent if requested by a first retry request.

In some embodiments, the retry controller 845 may operate based on a coding rate signal 847. For example, in some embodiments, a coding rate signal 847 may be used to set an actual coding rate (e.g., K/(K+m)). In some embodiments, the coding rate signal 847 may be determined, at least in part based, on a BER (e.g., an actual BER, a target BER, and/or the like) determined by a BER monitor 734.

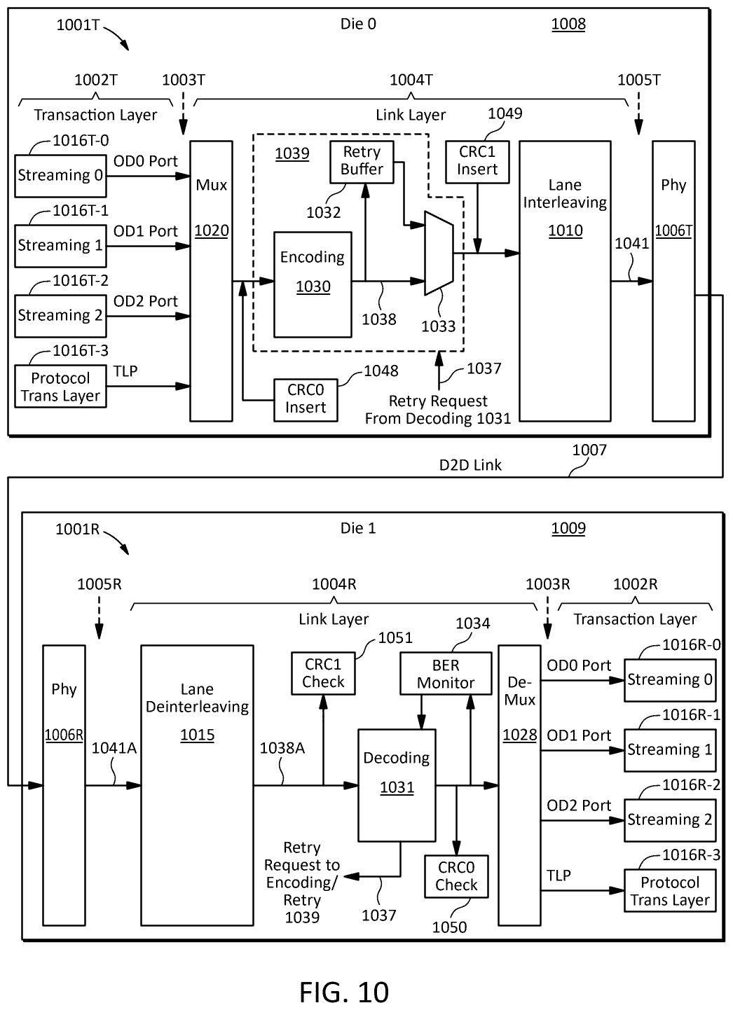

FIG. 10 illustrates another embodiment of an interface architecture for a D2D system having interleaving and error correction in accordance with example embodiments of the disclosure. The embodiment illustrated in FIG. 10 may include one or more elements that may be similar to those illustrated in FIG. 7, in which similar elements may be indicated by reference numbers ending in, and/or containing, the same digits, letters, and/or the like.

In the embodiment illustrated in FIG. 10, the link layer 1004T may include CRC0 insert logic 1048 and/or CRC1 insert logic 1049. Additionally, or alternatively, the link layer 1004R may include CRC0 check logic 1050 and/or CRC1 check logic 1051.

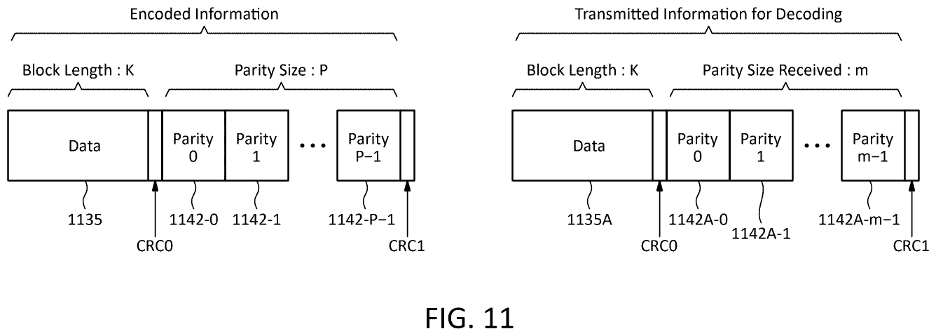

In some embodiments, the CRC0 insert logic 1048 and/or CRC0 check logic 1050 may insert and/or check CRC information in data information such as CRC0 in, or for, data information 1135 illustrated in FIG. 11 which illustrates an example embodiment of CRC information in data information and parity information in accordance with example embodiments of the disclosure.

In some embodiments, the CRC1 insert logic 1049 and/or CRC1 check logic 1051 may insert and/or check CRC information in parity information such as CRC1 in, or for, parity information 1142 illustrated in FIG. 11.

In the embodiment illustrated in FIG. 10, the link layer 1004T may include multiplexer logic 1020 that may be configured to multiplex two or more protocols, two or more protocol stacks, two or more protocols within a stack, and/or the like, in a manner similar to the multiplexer logic 420 illustrated in FIG. 4. Additionally, or alternatively, the link layer 1004R may include demultiplexer logic 1028 that may be configured to demultiplex two or more protocols, two or more protocol stacks, two or more protocols within a stack, and/or the like, in a manner similar to the demultiplexer logic 428 illustrated in FIG. 4.

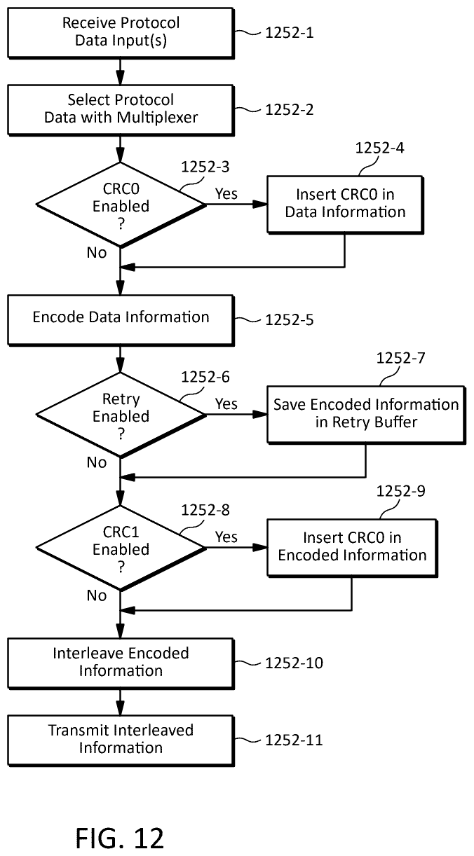

FIG. 12 illustrates an embodiment of a method for transmitting information using a D2D system in accordance with example embodiments of the disclosure. The embodiment illustrated in FIG. 12 may be implemented with, or used to implement, any of the D2D systems described herein. For purposes of illustration, the method illustrated in FIG. 12 may be described in the context of the architecture illustrated in FIG. 10.

The method may begin at operation 1252-1 where the method may receive one or more protocol data inputs. For example, one or more of the protocols 1016T may provide one or more protocol data inputs to the link layer 1004T using link layer interface 1003T.

At operation 1252-2, the one or more protocol data inputs may be multiplexed to select one source of protocol data to transmit. For example, the multiplexer logic 1020 may select an input from one of the protocols 1016T to transmit using the D2D system 1001T.

At operation 1252-3, the method may determine if a first CRC feature (e.g., CRC0) is enabled. If the first CRC feature is not enabled, the method may proceed to operation 1252-5. If, however, the first CRC feature is enabled, the method may insert, at operation 1252-4 a first CRC code in the protocol data. For example, CRC0 logic 1048 may insert CRC0 information in data information 1135 as illustrated in FIG. 11. In some embodiments, the first CRC information may be generated, for example, on a per protocol basis. The method may proceed to operation 1252-5.

At operation 1252-5, the method may use one or more error coding schemes to encode the data information. For example, encoding logic 1030 may generate encoded information 138 which may include, as illustrated in FIG. 8, data information 835 and/or parity information 842.

At operation 1252-6, the method may determine if a retry operation is enabled. If a retry operation is not enabled, the method may proceed to operation 1252-8. If, however, a retry operation is enabled, the method may save, at operation 1252-7, the encoded information in a retry buffer. For example, the error correction scheme 1039 may save the encoded information 1038 (which may include, as illustrated in FIG. 8, data information 835 and/or parity information 842) in the retry buffer 1032. The method may proceed to operation 1252-8.

At operation 1252-8, the method may determine if a second CRC feature (e.g., CRC1) is enabled. If the second CRC feature is not enabled, the method may proceed to operation 1252-10. If, however, the second CRC feature is enabled, the method may insert, at operation 1252-9 a second CRC code in the parity information. For example, CRC1 logic 1049 may insert CRC1 information in parity information 1142 as illustrated in FIG. 11. In some embodiments, the second CRC information may be generated, for example, by encoding logic. The method may proceed to operation 1252-10.

At operation 1252-10, the method may perform an interleaving operation on the data to be transmitted. For example, the lane interleaving logic 1010 may interleave information mapped to one or more lanes of a link 1007 using a technique such as that illustrated, for example, in FIG. 6.

At operation 1252-11, the method may transmit the interleaved information using a physical layer of a D2D system. For example, the physical layer 1006T may transmit the interleaved information 1041 using the link 1007. The method may end based on the transmission of the interleaved information.

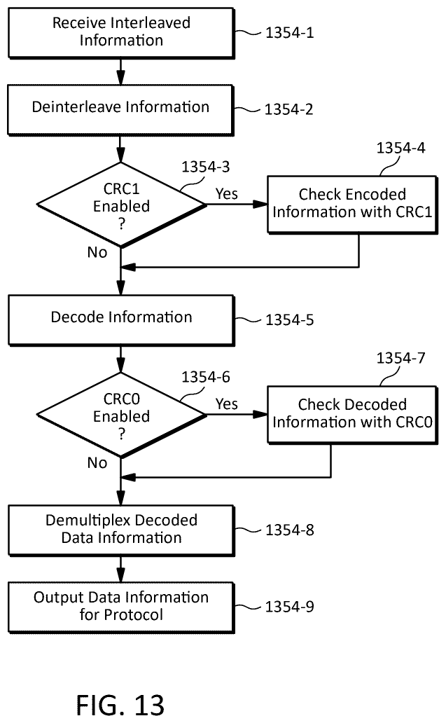

FIG. 13 illustrates an embodiment of a method for receiving information using a D2D system in accordance with example embodiments of the disclosure. The embodiment illustrated in FIG. 13 may be implemented with, or used to implement, any of the D2D systems described herein. For purposes of illustration, the method illustrated in FIG. 13 may be described in the context of the architecture illustrated in FIG. 10.

The method may begin at operation 1354-1 where the method may receive interleaved information using a physical layer of a D2D system. For example, the physical layer 1006R may receive the interleaved information 1041A using the link 1007.

At operation 1354-2, the method may perform a deinterleaving operation on the received information. For example, the lane deinterleaving logic 1015 may deinterleave the information 1041A mapped to one or more lanes of a link 1007 using a reverse process from that illustrated, for example, in FIG. 6.

At operation 1354-3, the method may determine if a second CRC feature (e.g., CRC1) is enabled. If the second CRC feature is not enabled, the method may proceed to operation 1354-5. If, however, the second CRC feature is enabled, the method may check, at operation 1354-4 information using a second CRC code. For example, CRC1 check logic 1051 may check parity information 1142A using CRC1 information as illustrated in FIG. 11. If the CRC check determines one or more (e.g., an unacceptable level of) errors are present in the parity information 1142A, the method may send a retry request. If the CRC check is successful, the method may proceed to operation 1354-5.

At operation 1354-5, the method may use one or more error decoding algorithms to decode the encoded information. For example, decoding logic 1031 may decode the encoded information 1038A using parity information such as parity information 842A illustrated in FIG. 8 to decode data information 835A as illustrated in FIG. 8.

At operation 1354-6, the method may determine if a first CRC feature (e.g., CRC0) is enabled. If the first CRC feature is not enabled, the method may proceed to operation 1354-8. If, however, the first CRC feature is enabled, the method may check, at operation 1354-7 information using a first CRC code. For example, CRC0 check logic 1050 may check data information 1135A using CRC0 information as illustrated in FIG. 11. If the CRC check determines one or more (e.g., an unacceptable level of) errors are present in the data information 1135A, the method may send a retry request. If the CRC check is successful, the method may proceed to operation 1354-8.

At operation 1354-8, the method may demultiplex the decoded data information to one or more protocols. For example, the demultiplexer logic 1028 may select one of multiple outputs using link layer interface 1003R.

At operation 1354-9, the method may provide the decoded data information to a selected protocol at a transaction layer. For example, the demultiplexer logic 1028 may provide the decoded data information to one of the protocols 1016R. The method may end based on providing the decoded data information as an output to the selected protocol.

Any of the functionality and/or components disclosed herein, including any of the interfaces, layers, interleaving logic, control circuits, error detection logic, error correction logic, encoding and/or decoding logic, and/or the like, may be implemented with circuitry such as combinational logic, sequential logic, gate arrays, timers, counters, registers, buffers, state machines, accelerators, embedded processors, processing units (e.g., central processing units (CPUs), graphics processing units (GPUs), neural processing units (NPUs), tensor processing units (TPUs), digital signal processors (DSPs)), and/or the like, some of which may execute instructions stored in any type of memory and/or implement any type of execution environment, and/or the like, or a combination thereof.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

In some embodiments, a portion of an element may refer to less than, or all of, the element. A first portion of an element and a second portion of the element may refer to the same portions of the element. A first portion of an element and a second portion of the element may overlap (e.g., a portion of the first portion may be the same as a portion of the second portion).

Since the inventive principles of this patent disclosure may be modified in arrangement and detail without departing from the inventive concepts, such changes and modifications are considered to fall within the scope of the following claims.

1. An apparatus comprising:
a die comprising at least one circuit configured to:
receive a first byte mapped to a first lane of two or more lanes of a die-to-die system;
receive a second byte mapped to a second lane of the two or more lanes of the die-to-die system;
transmit, using one lane of the two or more lanes of the die-to-die system, a portion of the first byte; and
transmit, using the one lane of the two or more lanes of the die-to-die system, a portion of the second byte.

2. The apparatus of claim 1, wherein the one lane of the two or more lanes of the die-to-die system is the first lane of the two or more lanes of the die-to-die system.

3. The apparatus of claim 1, wherein the one lane of the two or more lanes of the die-to-die system is a third lane of the two or more lanes of the die-to-die system.

4. The apparatus of claim 1, wherein the portion of the first byte is a first portion of the first byte, the portion of the second byte is a first portion of the second byte, the one lane of the two or more lanes of the die-to-die system is a first one lane of the two or more lanes of the die-to-die system, and the at least one circuit is configured to:
generate a fourth byte comprising a second portion of the first byte and a second portion of the second byte; and
transmit, using a second one lane of the two or more lanes of the die-to-die system, the fourth byte.

5. The apparatus of claim 4, wherein the second one lane of the two or more lanes of the die-to-die system is the second lane of the two or more lanes of the die-to-die system.

6. The apparatus of claim 4, wherein the second one lane of the two or more lanes of the die-to-die system is a third lane of the two or more lanes of the die-to-die system.

7. The apparatus of claim 1, wherein the at least one circuit is configured to:
generate error correction information for the portion of the first byte and the portion of the second byte; and
transmit, using a lane of the die-to-die system, at least a portion of the error correction information.

8. The apparatus of claim 7, wherein the at least one circuit is configured to generate the error correction information using variable rate coding.

9. An apparatus comprising:
a die comprising at least one circuit configured to:
receive data to transmit using a die-to-die system;
generate error correction information for the data;
encode the data and the error correction information to generate encoded information; and
transmit, using the die-to-die system, at least a portion of the encoded information.

10. The apparatus of claim 9, wherein the at least one circuit is configured to configured to generate the error correction information using variable rate coding.

11. The apparatus of claim 9, wherein the at least one circuit is configured to configured to generate the error correction information using an error correction code.

12. An apparatus comprising:
a die comprising at least one circuit configured to:
receive data to transmit using a die-to-die system;
generate error correction information for the data;
perform a first send operation comprising sending the data using the die-to-die system;
receive, based on the first send operation, a request; and
perform, based on the request, a second send operation comprising sending a portion of the error correction information.

13. The apparatus of claim 12, wherein the portion of the error correction information is a first portion of the error correction information, the request is a first request, and the at least one circuit is further configured to:
receive, based on the second send operation, a second request; and
perform, based on the second request, a third send operation comprising sending a second portion of the error correction information.

14. The apparatus of claim 12, wherein the portion of the error correction information is a first portion of the error correction information, and wherein:
the first send operation comprises sending a second portion of the error correction information.

15. The apparatus of claim 14, wherein the at least one circuit is configured to determine the first portion of the error correction information based on a coding rate.

16. The apparatus of claim 12, wherein the at least one circuit is configured to generate the error correction information using variable rate coding.

17. The apparatus of claim 12, wherein the at least one circuit is configured to generate the error correction information using a convolutional code.

18. The apparatus of claim 12, wherein the at least one circuit is configured to generate the error correction information using a turbo code.

19. The apparatus of claim 12, wherein the at least one circuit is configured to determine the portion of the error correction information based on a coding rate.

20. The apparatus of claim 12, wherein the at least one circuit comprises a buffer configured to store at least a portion of the error correction information.
